(19) United States
(12) Patent Application Publication
(10) Pub. No.: US 2006/0103585 A1
(43) Pub. Date: May 18, 2006

(54) Detector, system for the identification of articles and method for the production of said detector

(76) Inventor: Philippe Martin, Beaune (FR)

Correspondence Address: BACHMAN & LAPOINTE, P.C., 900 CHAPEL STREET, SUITE 1201, NEW HAVEN, CT, 06510, US

(21) Appl. No.: 10/542,328

(22) PCT Filed: Jan. 16, 2004
(86) PCT No.: PCT/FR04/00097

§ 371 Date: Sep. 26, 2005

(30) Foreign Application Priority Data
Jan. 16, 2003 (FR) 0300458

(51) Int. Cl. H01Q 1/36

(52) U.S. Cl. 343/895

(57) ABSTRACT

A detector of articles comprising a contactless RF-ID type label comprises at least one antenna formed by N loops and M turns, together being greater than or equal to 1, characterized in that at least one of the turns is made up of at least two complementary segments, the two segments not being coplanar. The present invention also relates to an identification system comprising the detector and to a method for the production of the detector.

### BACKGROUND OF THE INVENTION

(1) Field of the Invention

The present invention relates to the field of systems for the identification of objects or articles carrying a radiofrequency antenna of the RFID type associated with an electronic circuit such that it can be interrogated by an interrogation device comprising a radiofrequency antenna. It relates in particular, but not exclusively, to the identification of CDs or DVDs in shops for the hire/sale of films. In the following description it has been chosen to apply the invention to a device delivering DVDs in which the DVDs, each carrying a contactless label of the RFID type, are arranged close to each other, that is to say at a distance of less than 15 millimeters (mm). The present invention can of course be useful in various other applications.

(2) Prior Art

At the present time, there is known a machine for renting DVDs and video cassettes comprising an identification device comprising a conventional antenna, that is to say constituted by a conductor element disposed as a spiral and extending in one and the same plane. The field generated by this antenna is located in a plane perpendicular to the plane of the spiral and feeds an intermediate element. This intermediate element conventionally consists of a printed circuit comprising an LC circuit with a passive antenna tuned to the frequency of 13.56 MHz (Megahertz) and is particularly thin in order to be inserted in the housings of the articles for hire: the said intermediate element in its turn feeding the contactless label carried by each of the articles. It is of course imperative that the magnetic field generated by the identification device is sufficiently strong to make it possible to feed the intermediate element.

This configuration functions relatively well for conventional hiring machines, in which the DVDs and/or video cassettes are spaced by a consistent distance, usually of about 40 millimeters. Thus, because of this distance separating two RFID labels, the risks of confusion of the identification device are relatively minimal.

However, present-day hiring machines have the disadvantages of being bulky and of not being able to contain a large number of articles for hire. Thus, a new type of hiring machine has been proposed in which the DVDs and/or the video cassettes are spaced by a small distance, less than 15 millimeters, thus making it possible to contain a much greater number of articles for hire.

Unfortunately, the present-day identification devise do not make it possible to faultlessly identify the contactless labels of the RFID type present on articles with the latter of so close to each other. In fact, the proximity of the RFID labels has the consequence that the identification devices will “see” several labels that are present in the field generated by the identification device.

### SUMMARY OF THE INVENTION

The purpose of the invention is therefore to overcome this disadvantage. For this purpose it proposes a detector of articles comprising a contactless label of the RFID type, the said detector comprising at least one antenna formed of N loops and M turns, M and N being integers greater than or equal to 1, characterized in that at least one of the said turns consists of at least two complementary segments, the two segments not being coplanar, that is to say that the addition starting from the ends of one of the segments of the other segment constitutes a turn, and each one is present of one of two different substrate layers.

It will of course also be possible to envisage the detector according to the invention being used for the recording, or entry, of data or information in the contactless label of the article.

The expression “complementary segments” refers to the fact that the addition, starting from the ends of the segments, of other segments constitutes a segment extending over 360°, also referred to below as a complete turn.

Advantageously, at least one of the turns of the antenna will be constituted by at least two segments extending in different planes. In the same way, the planes in which the two said segments extend will be parallel with each other.

Preferably, the ends of each of two consecutive segments will be connected to each other by a bridge.

According to one embodiment of the invention, the connection between the ends of the segments will be such that the said antenna exhibits N loops with 1 turn.

According to another embodiment of the invention, the connection between the ends of the segments will be such that the said antenna exhibits 1 loop with N turns.

According to one possibility offered by the invention, the said bridge will extend perpendicular to the planes of the said segments of turn.

The present invention also relates to a system for the identification of articles comprising contactless labels of the RFID type, comprising a detector for detecting the said labels, and an antenna formed from several turns, characterized in that at least one of the said turns is constituted by at least two complementary segments, the two segments not being coplanar, and in that the said detector comprises a thin casing comprising an electrical circuit.

According to one method of embodiment of the invention, the said antenna will be contained in a substantially parallelepipedic card, having two large parallel faces.

Preferably, the said electrical circuit will extend in a plane substantially perpendicular to the planes of the said large parallel faces of the card. In this case, the said electrical circuit will extend parallel with the contactless label of the RFID type of the article.

According to an advantageous aspect of the invention, the articles will be disposed close to each other, at a distance of less than 40 millimeters (mm), preferably a distance of less than 15 mm.

Preferably, the said antenna will be tuned, with an impedance of 50 Ω (Ohms) and with zero phase shift, to the frequency of 13.56 MHZ (Megahertz).

The present invention also relates to a method of manufacture of a detector as described above, the said method comprising the steps of:

production of at least one electrical conductor segment on a plurality of substrates respectively,

multi-layer assembly of the said substrates.

Advantageously, the method of manufacture will also comprise a step of production of connection, or bridging, between the different segments of each of the substrates.

Because of these features, the invention makes it possible to detect and to find, faultlessly and without risk of confusion, a particular article requested by a user.

### BRIEF DESCRIPTION OF THE DRAWINGS

The invention will be understood better with the help of the description of one embodiment of the invention, given hereafter purely by way of explanation and with reference to the appended drawings:

FIG. 1 shows a schematic view of a detector according to the invention, of an intermediate element and of a DVD carrying an RFID label;

FIG. 2 shows a perspective view of the detector with an antenna according to the invention and an electronic supply circuit;

FIG. 3 shows a front view of the different substrates constituting a detector according to the invention.

### DETAILED DESCRIPTION OF THE PREFERRED EMOBIDMENT(S)

A DVD hiring machine, not shown in the figures, generally uses cylindrical trays whose ends comprise a plurality of housings, each one containing a DVD.

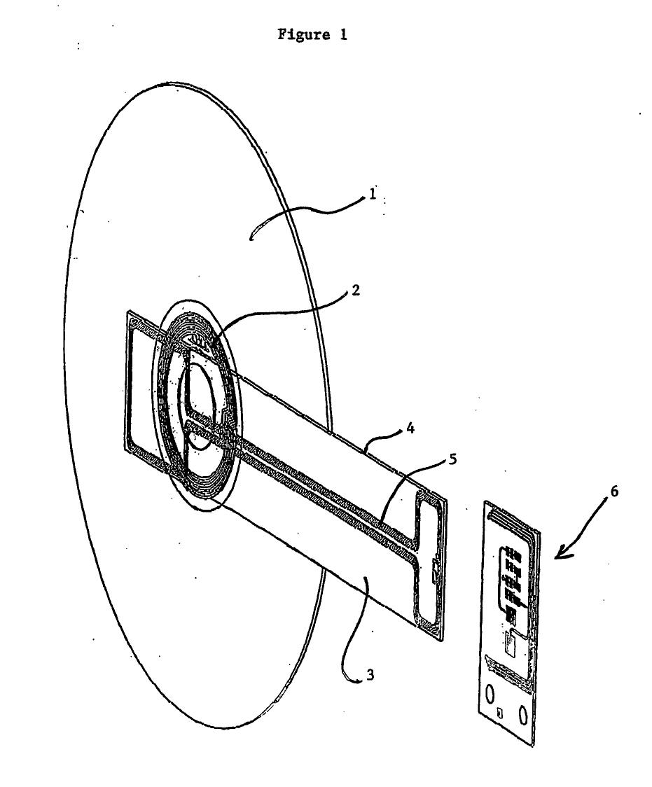

As shown in FIG. 1, the DVD 1 comprises a contactless label 2, for example of the RFID type, disposed at the centre of the DVD. This RFID label 2, also called an electronic label, comprises a radiofrequency antenna associated with an electronic circuit. The electronic circuit comprises at least one memory containing the identification characteristics of the article, in this instance in particular the title of the film. When this label is interrogated by an interrogation device, via an electromagnetic field, the label 2 transmits in return a message containing the requested information.

The electronic circuit and the communication of a contactless label 2 of the RFID type are well known and will not be described in more detail here.

FIG. 1 also shows an intermediate element 3 intended to transmit an electromagnetic field as far as the said label 2. This intermediate element 3, of parallelepipedic shape, consists of an extremely thin casing containing an electrical circuit 5. The electrical circuit 5 extends over the whole length of the casing 4 such that one of its ends is disposed close to the detector 6 according to the invention while the other end is disposed close to the contactless label 2 carried by the article 1. The intermediate element 3, consisting of a passive antenna, is necessary in the particular type of usage of a DVD hiring machine such as described above since the housings containing the DVDs are narrow and do not allow the detector 6 to be placed directly contiguous with the contactless label 2 of the article 1.

It is recalled here that a passive antenna is conventionally constituted by a capacitor and a coil or turn antenna. This passive antenna is usually tuned to the frequency of 13.56 MHz.

The detector 6 of the invention comprises several substrate layers 7, 8, 9, 10, 11 upon which at least one electrical conductor segment 12 is present. The substrate layers 7, 8, 9, 10, 11 comprising a conductor segment 12 are produced conventionally, for example either by etching a conductive plate or by depositing an electrically conductive metal or alloy on a non-conductive substrate.

Then, the substrate layers 7, 8, 9, 10, 11 are joined to each other in order to form the multi-layer detector 6, having the shape of a parallelepipedic card, in order to exhibit an antenna 13 formed by a plurality of segments 12 disposed in different planes and connected by bridges 14 that are also conductive. The method of fixing the different substrate layers 7, 8, 9, 10, 11 is known to those skilled in the art and uses for example, fixing by gluing.

The detector 6 of the invention therefore comprises an antenna 13 constituted from a plurality of segments 12 by bridges 14; the said antenna 13 being associated with an electronic circuit 15 comprising the conventional components for generating an electromagnetic field with this antenna 13, namely and in particular at least one capacitor and an electrical power supply source, possibly external.

The segments 12 of the antenna 13 can essentially be connected in two different ways.

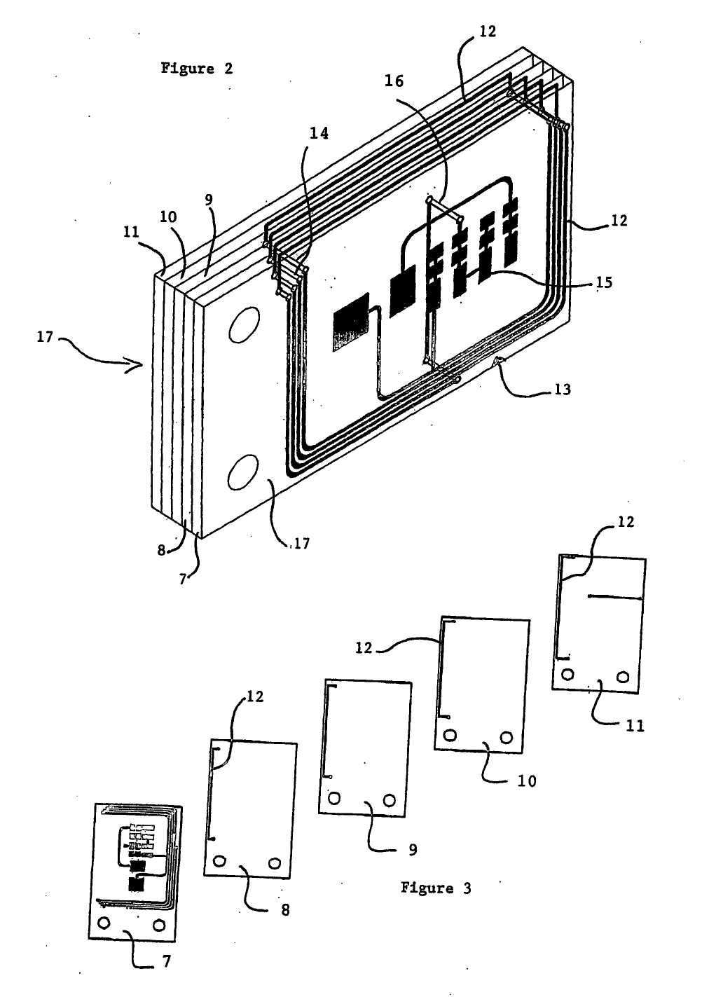

In a first embodiment, shown in FIG. 2, at least one of the ends of each segment 12 is connected by a separate bridge 16 to another segment 12 such that the antenna 13 forms a single loop having four turns.

The term “turn” means a complete winding, either through 360°, or a partial one, though less than 360° of one part of the antenna 13. Thus, a turn is constituted by a connection between segments 12 together forming a complete or partial turn to then return into the axis of an arbitrarily chosen starting point.

The term “loop” means a winding of the antenna without intersection, that is to say without crossing with more than two directions.

Thus, it is also possible to envisage producing the bridging of the segments 12 of the antenna 13 by connecting directly, and ideally in two perpendicular axes, the opposite ends of each segment 12 respectively. In this configuration, there are therefore N loops of 1 turn.

Thus, in its widest acceptance, the antenna 13 according to the invention is formed of N loops and M turns, M and N being integers greater than or equal to 1.

The antenna 13 according to the invention has a noteworthy effect since it makes it possible to propagate a sufficiently powerful magnetic field along at least one of its sides, or edges, from the parallelepipedic card constituting the detector 6, that is to say through the small sides perpendicular to the two large parallel faces 17 of the card. Because of this device, the detector 6 can be brought edgewise close to the intermediate element 3 and power the latter sufficiently.

The detector 6 thus occupies a small space since it can be presented edgewise and dispense a sufficiently powerful magnetic field to power the intermediate element 3. In the systems of the prior art, the card or the detector comprising the antenna is necessarily presented by its face, since there is no magnetic field propagated through the shall sides, or an electromagnetic field that is so weak that it does not make it possible to power the intermediate element 3.

It is recalled that one of the objectives of the present invention is to solve the problems of identification when the said articles 1 are disposed substantially parallel with each other and at a distance of the order of 14 millimeters.

The detector according to the invention can also be envisaged in different applications, in particular in a library:

The said detector is connected to an RFID reader which provides it with energy making it possible to generate an electromagnetic field at its level. By construction, this antenna, or detector, delivers a very directional magnetic field which, because of this, illuminates only the elements placed in its beam. The operation considered here, namely the inventory of works in a library, consists in carrying out the reading or decoding of electronic labels placed in the works and allowing their individual identification.

This antenna, or detector, carries out this operation very quickly, without moving the works from their location and placing, given that during the displacement of the antenna all along the works, very few elements are energized at the same time, and are therefore decoded one after the other faster than if a large number of these elements were active at the same time; in fact, in this case, the operation would be slowed down by the anti-collision process. Furthermore, as this antenna has the ability to identify the elements one after the other, this operation also makes it possible to give the order in which the works are placed, and therefore to detect incorrectly positioned elements or to locate one element precisely from among all of the elements.

The invention is described above by way of example. It is understood that those skilled in the art are capable of producing different variants of the invention without by so doing departing from the scope of the patent.

1-16. (canceled)

17. A detector of articles comprising a contactless label of the RFID type, said detector comprising at least one antenna formed of N loops and M turns, M and N being integers greater than or equal to 1, wherein at least one of the turns consists of at least two complementary segments, the two complementary segments not being coplanar, and being arranged so that an addition of one of said complementary segments starting from an end thereof to another of said complementary segments constitutes a turn, and each segment is present on one of two different substrate layers.

18. The detector as claimed in claim 17, wherein at least one of the turns of the antenna is constituted by at least two segments extending in different planes.

19. The detector as claimed in claim 18, wherein the planes in which the at least two segments extend are parallel with each other.

20. The detector as claimed in claim 18, wherein the ends of each of two consecutive segments are connected to each other by a bridge.

21. The detector as claimed in claim 20, wherein the connection between the ends of the segments is such that the antenna exhibits N loops with one turn.

22. The detector as claimed in claim 20, wherein the connection between the ends of the segments is such that the antenna exhibits one loop with N turns.

23. The detector as claimed in claim 20, wherein the bridge extends perpendicular to the planes of the segments of turn.

24. A system for the identification of articles comprising contactless labels of the RFID type, comprising an intermediate element and an antenna formed from several turns, at least one of the turns being constituted by at least two complementary segments, the at least two segments not being coplanar, and said intermediate element comprising a thin casing comprising an electrical circuit.

25. The system as claimed in claim 24, wherein said antenna is contained in a substantially parallelepipedic card having two large parallel faces.

26. The system as claimed in claim 25, wherein said electrical circuit extends in a plane substantially perpendicular to planes of said large parallel faces of the card.

27. The system as claimed in claim 24, wherein said electrical circuit extends parallel with the contactless label of the RFID type of an article.

28. The system as claimed in claim 24, wherein articles are disposed substantially parallel with respect to each other.

29. The system as claimed in claim 24, wherein articles are disposed close to each other, at a distance of less than 40 millimeters (mm).

30. The system as claimed in claim 29, wherein said distance is less than 15 mm.

31. The system as claimed in claim 24, wherein said antenna is tuned, with an impedance of 50 Ω (Ohms) and with zero phase shift, to the frequency of 13.56 MHZ (Megahertz).

32. A method of manufacture of a detector as claimed in claim 17, comprising the following steps:
producing at least one electrical conductor segment on a plurality of substrates respectively, and
assembling multiple layers of said substrates.

33. The method as claimed in claim 32, further comprising a step of producing a connection between different segments of each of the substrates.
